(19) United States
(12) Patent Application Publication
(10) Pub. No.: US 2018/0073442 A1
(43) Pub. Date: Mar. 15, 2018

(54) ENGINE AIR INDUCTION CONTROL SYSTEM INCLUDING A THROTTLE VALVE ASSEMBLY

(71) Applicant: Ford Global Technologies, LLC, Dearborn, MI (US)

(72) Inventor: William Gerald Barr, Chelmsford (GB)

(21) Appl. No.: 15/681,271

(22) Filed: Aug. 18, 2017

(30) Foreign Application Priority Data
Sep. 12, 2016 (GB) 1615449.4

(51) Int. Cl. F02D 9/10; F02D 9/12; F02D 41/00

(52) U.S. Cl. CPC F02D 9/101; F02D 9/12; F02D 2009/022; F02D 41/0002; F02D 9/1065

(57) ABSTRACT

An engine air induction control system having throttle valve assembly is disclosed, the throttle valve assembly having a streamlined divergent-convergent valve member slidingly mounted within a divergent-convergent valve chamber defined by a wall of a throttle body. The streamlined valve member is moveable towards and away from an inlet passage of the throttle body by an actuator mechanism to vary an annular air flow area defined between the valve member and the wall defining the valve chamber.

### CROSS REFERENCE TO RELATED APPLICATION

The present application claims priority to Great Britain Patent Application No. 1615449.4, filed Sep. 12, 2016. The entire contents of the above-referenced application are hereby incorporated by reference in its entirety for all purposes.

### FIELD

This disclosure relates to the control of air flow into an internal combustion engine and in particular to an engine air induction control system having a throttle valve assembly for controlling air flow into an internal combustion engine.

### BACKGROUND/SUMMARY

It is known to use a butterfly type valve to control the flow of air into an internal combustion engine. It will be appreciated that the term ‘air’ as meant herein includes not only atmospheric air admitted via an air inlet but also other gas flows to the engine such as, for example, recirculated exhaust gas and crankcase ventilation gas.

It is a problem with such a butterfly arrangement that when the butterfly valve is in a partially open position considerable downstream turbulence is produced which has an adverse effect on engine efficiency. Even at wide open throttle there will be a pressure drop and turbulence from the throttle plate of a butterfly type valve.

It is an object of this disclosure to provide a more efficient type of throttle valve for use in an engine air induction control system.

According to a first aspect of the disclosure there is provided an engine air induction control system for a motor vehicle comprising an air inlet flow path to an engine including a throttle valve assembly comprising a throttle body defining inlet and outlet air flow passages connected via a divergent-convergent valve chamber, a divergent-convergent streamlined valve member moveably mounted in the valve chamber of the throttle body to define an adjustable flow area air flow passage through the valve chamber and an actuator mechanism to move the streamlined valve member towards and away from the inlet air flow passage to vary the flow area of the air flow passage in the valve chamber, an electronic controller, an accelerator pedal position sensor associated with an accelerator pedal of the motor vehicle to provide a driver torque demand input to the electronic controller and an electronically controllable actuator forming part of the actuator mechanism of the throttle valve assembly operably connected to the electronic controller.

Optionally, the valve chamber and the streamlined valve member may both be circular in transverse cross-section and the air flow passage may be an annular air flow passage.

Moving the streamlined valve member in the valve chamber from a wide open throttle position towards the inlet passage may reduce the flow area of the air flow passage and moving the streamlined valve member in the valve chamber from a fully closed position away from the inlet passage may increase the flow area of the air flow passage.

In the wide open throttle position, a location on the valve member where the diameter of the valve member is substantially at a maximum may be aligned with a location in the valve chamber where the diameter of the valve chamber is substantially at a maximum.

In the fully closed throttle position, a location on the valve member where the diameter of the valve member is substantially at a maximum may be aligned with a location in the valve chamber close to a position where the inlet air flow passage joins the valve chamber so that a small gap is provided between the wall of the valve chamber and the streamlined valve member.

Alternatively, in the fully closed throttle position, the valve member may abut a wall of the valve chamber.

The streamlined member may have a streamlined nose portion and a tail portion that tapers to a point.

The actuator mechanism may be operable to move the streamlined valve member axially along a longitudinal axis of the throttle body.

The actuator mechanism may be an electronically controllable actuator mechanism including an electric motor drivingly connected to the streamlined valve member by a threaded shaft engaged with a threaded member attached to the streamlined valve member.

The electronic controller may be arranged to operate the electronically controllable actuator to move the valve member of the throttle valve assembly based upon the input from the accelerator pedal position sensor.

The electronic controller may be operable to use the electronically controllable actuator to move the valve member in the valve chamber of the throttle valve assembly to increase the air flow area in the throttle passage of the throttle body assembly from the current air flow area if the input from the accelerator pedal position sensor indicates a request for increased engine torque.

The electronic controller may be operable to use the electronically controllable actuator to move the valve member in the valve chamber of the throttle valve assembly to reduce the air flow area in the throttle passage of the throttle body assembly from the current air flow area if the input from the accelerator pedal position sensor indicates a request for reduced engine torque.

According to a second aspect of the disclosure there is provided a motor vehicle having an internal combustion engine and an engine air induction control system constructed in accordance with said first aspect of the disclosure.

### BRIEF DESCRIPTION OF THE DRAWINGS

FIG. 1 is a schematic diagram showing a motor vehicle according to a third aspect of the disclosure having an engine air induction control system in accordance with a second aspect of the disclosure that includes a throttle valve assembly constructed in accordance with a first aspect of the disclosure.

FIG. 2 is a diagrammatic cut-away side view of a throttle valve assembly constructed in accordance with said first aspect of the disclosure showing a streamlined valve member in a throttle closed position.

FIG. 3 is a diagrammatic cut-away side view similar to FIG. 2 but showing the streamlined valve member in a wide open throttle position.

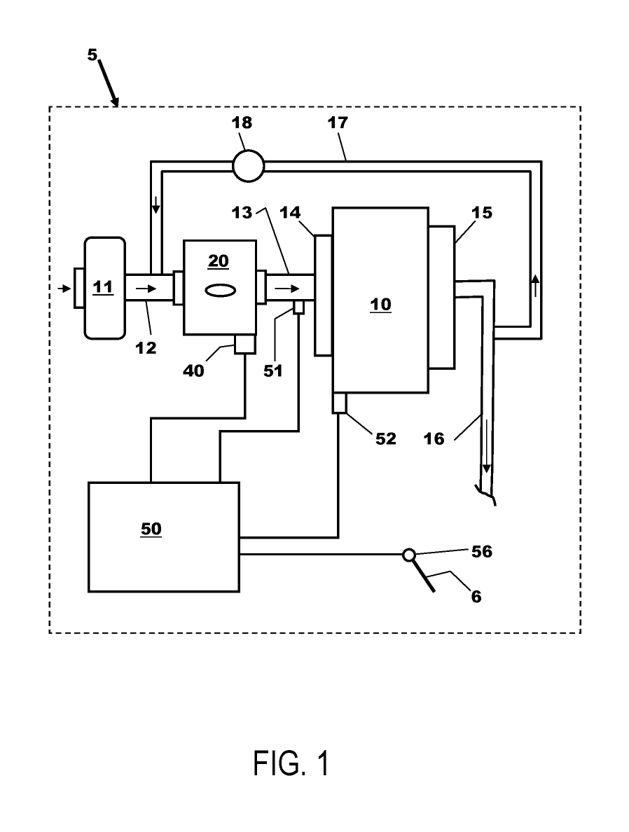

With reference to FIG. 1, there is shown a motor vehicle 5 having a direct injection gasoline engine 10.

### DETAILED DESCRIPTION

Air is supplied to the engine 10 via an air inlet manifold 14 and exhaust gasses flow out from the engine to atmosphere via an exhaust manifold 15 and an exhaust pipe 16. It will be appreciated that one or more emission control devices (not shown) will normally be included in the flow path of the exhaust gas from the engine 10 to atmosphere.

Atmospheric air enters a first induction duct 12 via an air filter 11 and flows through an air flow passage forming part of a throttle valve assembly 20 to a second induction duct 13 which is connected to the inlet manifold 14 of the engine 10.

An exhaust gas recirculation system comprises an exhaust gas recirculation pipe 17 connected at one end to the exhaust pipe 16 and connected at an opposite end to the first induction duct 12. An exhaust gas recirculation valve 18 is used as is well known in the art to control the flow of exhaust gas through the exhaust gas recirculation pipe 17. It will be appreciated that in practice the exhaust gas may flow through an intercooler before flowing back to the first induction duct 12 and that the disclosure is not limited to a normally aspirated engine having exhaust gas recirculation of the type shown.

The throttle valve assembly 20 forms part of an engine air induction control system that also includes an electronic controller 50 and a number of sensors of which only a mass air flow sensor 51, an engine speed sensor 52 and an accelerator pedal position sensor 56 associated with an accelerator pedal 6 are shown in FIG. 1.

The electronic controller 50 is shown in FIG. 1 as a conventional microcomputer including non-transitory memory or read only memory for storing executable instructions, the instructions for performing the methods described herein. The electronic controller 50 is shown receiving various signals from sensors coupled to the engine 10, and transmitting instructions to various actuators. The sensors may include the accelerator position sensor 56, engine speed sensor 52 and mass air flow sensor 51, for example. The electronic controller 50 may control an actuator such as those described herein.

It will be appreciated that in practice the electronic controller 50 will normally also control the flow of fuel to the engine 10 and that the fuel supply system has been omitted from FIG. 1 as it is not directly relevant to this disclosure.

Although not shown in FIG. 1, the electronic controller 50 is also connected to the exhaust gas control valve 18 to control the flow of exhaust gas flowing through the exhaust gas recirculation pipe 17.

The throttle valve assembly 20 includes an electronically controlled actuator in the form of an electric motor 40 that is controlled by the electronic controller 50. It will be appreciated that the electronic controller 50 may in practice not directly control the electric motor 40 but rather control a power controller used to control the electric motor 40. The electric motor 40 may be of a servo motor type having feedback but a micro-stepping motor could alternatively be used. It will be appreciated that a linear actuator could be used and that the disclosure is not limited to the use of a rotary electric actuator.

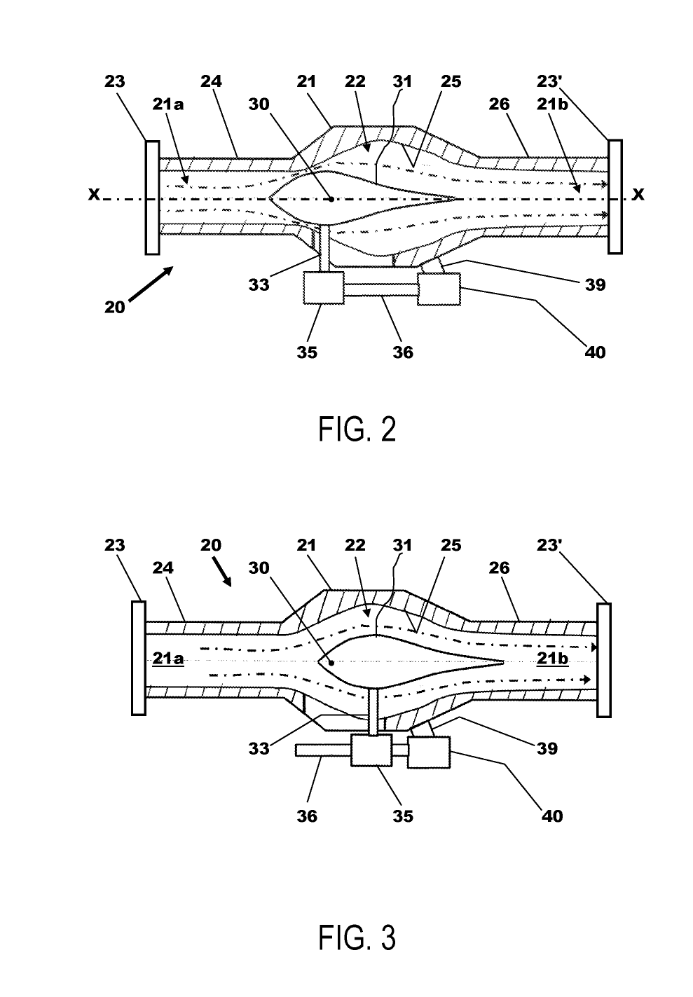

With particular reference to FIGS. 2-3 the throttle valve assembly 20 comprises a throttle body 21 defining a divergent-convergent valve chamber 22 in which is moveably mounted a divergent-convergent streamlined valve member 30.

The position of the streamlined valve member 30 is adjustable by the electric motor 40 via an actuator linkage comprising an arm 33 connected at one end to the streamlined valve member 30 and at an opposite end to a threaded member 35, a threaded drive shaft 36 threadingly engaged with the threaded member 35 and driveably connected to the electric motor 40 and a bracket 39 supporting the electric motor 40 on the throttle body 21. The electric motor 40, threaded member 35 and threaded shaft 36 that form in combination an electronically controllable actuator mechanism.

The streamlined valve member 30 has a body having a streamlined nose portion which can be in the form of a circular conical form or circular paraboloid form and a rear or tail portion that tapers to a point. The valve member 30 is divergent-convergent in shape having a maximum diameter where the nose portion meets the tail portion. The valve member 30 has a longitudinal axis that is arranged co-incident to a longitudinal axis X-X (Shown on FIG. 2) of the throttle body 21.

The term ‘streamlined’ as meant herein is a shape that produces little resistance to the flow of air and produces little downstream turbulence.

The streamlined valve member 30 can be of various shapes such as ‘teardrop’ and ‘ovoid’ and is not limited to a specific shape apart from the requirement for the streamlined valve member to be divergent-convergent in form and may be circular in cross-section.

Optionally, the streamlined valve member 30 has a tail portion that tapers in the direction of flow because such a shape minimizes downstream turbulence.

The divergent-convergent valve chamber 22 is defined by a wall 25 of the throttle body 21 which also has a first flange 23 at an inlet end of the throttle body 21 for use in attaching the throttle body 21 to the first induction duct 12 and a second flange 23′ at an outlet end of the throttle body 21 for use in connecting the throttle body 21 to the second induction duct 13.

A cylindrical inlet air flow passage 21a is formed at the inlet end of the throttle body 21 by an inlet portion 24 of the throttle body 21 and a circular in cross-section outlet air flow passage 21b is formed at the outlet end of the throttle body 21 by an outlet portion 26 of the throttle body 21.

The inlet and outlet passages 21a and 21b are arranged on the longitudinal axis X-X of the throttle body 21 so as to define an aligned flow passage through the throttle body 21 between the inlet passage 21a and the outlet passage 21b.

The inlet passage 21a extends from the flange 23 to a position where it joins the valve chamber 22 and the outlet passage 21b extends from the opposite end of the valve chamber 22 to the flange 23.

The valve chamber 22 and the streamlined valve member 30 are both circular in transverse cross-section having respective centers located on the longitudinal axis X-X of the throttle body 21. Between the body of the streamlined valve member 30 and the wall 25 defining the valve chamber 22 an annular air flow passage is defined of adjustable or variable flow area dependent upon the position of the streamlined valve member 30 in the valve chamber 22.

It will be appreciated that the streamlined valve member 30 and the valve chamber 22 are of the same cross-sectional shape in transverse cross-section and although this shape may be in the form of a circle to aid manufacturing they could alternatively be oval in cross-section.

In a ‘wide open throttle position’, the streamlined valve member 30 is positioned in the valve chamber 22 so that a location on the body of the valve member 30 where the diameter of the valve member 30 is substantially at a maximum is aligned with a location on the wall 25 of the valve chamber 22 where the diameter of the valve chamber 22 is substantially at a maximum.

In a ‘fully closed throttle position’, the location where the diameter of the valve member 30 is substantially at a maximum is aligned with a location on the wall 25 of the valve chamber 22 close to a position where the inlet passage 21a joins the wall 25 of the valve chamber 22. Therefore even in the fully closed throttle position there is still a small annular flow passage provided with this arrangement.

In alternative embodiments, in the fully closed throttle position, the streamlined valve member 30 abuts the wall 25 of the valve chamber 22 at a position at or close to a position where the diameter of the valve chamber 22 is substantially at a minimum or at a position at or near a position where the wall 25 of the valve chamber 22 meets the inlet air flow passages 21a. In such cases no flow area is provided in the fully closed position and a bypass passage would normally need to be provided to enable idle running of the engine 10.

It will be appreciated that moving the streamlined valve member 30 in the valve chamber 22 from the wide open throttle position towards the inlet passage 21a will reduce the flow area of the annular air flow passage through the valve chamber 22 and moving the streamlined valve member 30 in the valve chamber 22 from the fully closed position away from the inlet passage 21a will have the effect of increasing the flow area of the annular air flow passage through the valve chamber 22.

It will be appreciated that the actuator mechanism is operable to move the streamlined valve member 30 axially along the longitudinal axis X-X of the throttle body 21 between the wide open and fully closed positions by causing the electric motor 40 to drive the threaded shaft 36 in a desired direction of rotation to effect the required motion of the streamlined valve member 30. Due to the engagement of the threaded shaft 36 with the threaded member 35 that is connected to the streamlined valve member 30 by the arm 33 the rotational motion of the threaded shaft 36 will cause the streamlined valve member 30 to be displaced in a desired direction.

Operation of the throttle valve assembly will now be described.

From the fully closed throttle position shown in FIG. 2, to increase the air flow area of the throttle body 21 and hence the flow rate of air through the throttle body 21 the streamlined valve member 30 is moved away from the inlet passage 21a until it reaches a maximum displaced position called the wide open throttle position as shown in FIG. 3. The movement of the streamlined valve member 30 is effected by the electric motor 40 which rotates the threaded drive shaft 36 which causes the tubular threaded member 35 fastened to the streamlined valve member 30 to be drawn towards the motor 40.

From the wide open throttle position shown in FIG. 3, to reduce the air flow area through the throttle body 21 and hence the flow rate of air through the throttle body 21 the streamlined valve member 30 is moveable towards the inlet passage 21a until it reaches a minimum displaced position ‘the closed throttle position’ as shown in FIG. 2. The movement of the streamlined valve member 30 is effected by the electric motor 40 which rotates the threaded drive shaft 36 which causes the tubular threaded member 35 fastened to the streamlined valve 30 to be moved away from the motor 40.

It will be appreciated that the streamlined valve member 30 can be located at any position between the fully closed and wide open positions depending upon the requirement for air from the engine 10. Movement of the valve body 31 away from the inlet passage 21a is termed ‘movement in a throttle opening direction’ and movement of the valve body 31 towards the inlet passage 21a is termed ‘movement in a throttle closing direction’.

Due to the use of the streamlined valve member 30 and the internal shape of the throttle body 21 no sudden change of direction is required for the air flowing through the throttle body 21 and so turbulence is considerably reduced compared to a conventional butterfly valve.

It will be appreciated that the throttle body 21 shown in FIGS. 2-3 is conceptual in nature and that in practice there would need to be a seal between the throttle body 21 and the arm 33 used to move the streamlined valve member 30. Furthermore, the throttle body 21 would need to be split or constructed in such a manner as to permit the assembly of the streamlined valve member 30 in the valve chamber 22.

With particular reference to FIG. 1 operation of the engine air induction control system will now be described.

A demand for torque from the engine 10 is produced when an accelerator pedal such as the accelerator pedal 6 is depressed and the amount of torque demanded by the driver will depend upon the magnitude of depression of the accelerator pedal 6.

Although in some cases there is a linear relationship between the magnitude of accelerator pedal 6 depression and torque demand in other cases the relationship may not be linear. However, irrespective of the relationship, in general terms when a driver depresses the accelerator pedal 6 a demand for torque is produced that increases with increasing depression of the accelerator pedal 6 and this is sensed by the accelerator pedal position sensor 56 and is supplied as a torque demand input to the electronic controller 50.

The electronic controller 50 uses the input from the accelerator pedal position sensor 56 to control the position of the streamlined valve member 30 in the throttle body 21 by causing the electric motor 40 to be rotated in a desired direction.

For example, if the demand for torque from the driver increases from a current torque demand then the electronic controller 50 is operable to cause the motor 40 to move the streamlined valve member 30 in throttle opening direction, that is to say away from the inlet passage 21a, so as to increase the flow rate of air to the engine 10. It will be appreciated that the amount of fuel supplied to the engine 10 will also be adjusted by the electronic controller 50 to produce a desired air fuel ratio.

Similarly, if the demand for torque from the driver reduces from the current demand then the electronic controller 50 is operable to cause the motor 40 to move the streamlined valve member 30 in a throttle closing direction, that is to say towards the inlet passage 21a, to reduce the flow rate of air to the engine 10 and the amount of fuel supplied to the engine 10 will be adjusted by the electronic controller 50 to produce a desired air fuel ratio.

It will be appreciated that the electronic controller 50 may also be operable to vary the position of the streamlined valve member 30 and/or the amount of fuel supplied during constant engine running conditions in which the position of the accelerator pedal 6 is not adjusted by the driver in order to maintain a required air fuel ratio or to control emissions from the engine 10.

When the driver is not depressing the accelerator pedal 6 the controller 50 is operable to move the streamlined valve member 30 to the fully closed throttle position shown in FIG. 2 and when the driver fully depresses the accelerator pedal 6 the electronic controller 50 is arranged to move the valve member 30 to the wide open throttle position shown in FIG. 3.

Although the disclosure has been described with reference to an embodiment using a rotary electric actuator it will be appreciated that other types of actuator could be used such as for example a linear actuator. It will also be appreciated that the actuator could alternatively be an electronically controllable hydraulic actuator or an electronically controllable pneumatic actuator.

It will be appreciated that in its simplest form the throttle valve assembly could use a manual actuation mechanism having a mechanical linkage between an accelerator pedal and the streamlined valve member but it is advantageous if an electronically controlled actuation mechanism is used.

It will be appreciated that the disclosure is not limited to use on a direct injection gasoline engine and could be used on any engine requiring an electronically controllable throttle valve.

Therefore in summary, the disclosure provides a throttle valve assembly that reduces the turbulence caused by the valve compared with a butterfly type throttle valve and produces the following advantages: improved fuel economy, improved maximum torque, improved power; and, improved exhaust emissions, including CO2.

It will be appreciated by those skilled in the art that although the disclosure has been described by way of example with reference to one or more embodiments it is not limited to the disclosed embodiments and that alternative embodiments could be constructed without departing from the scope of the disclosure as defined by the appended claims.

1. An engine air induction control system for a motor vehicle, comprising:
an air inlet flow path to an engine including a throttle valve assembly comprising a throttle body defining inlet and outlet air flow passages connected via a divergent-convergent valve chamber;
a divergent-convergent streamlined valve member moveably mounted in the valve chamber of the throttle body to define an adjustable flow area air flow passage through the valve chamber;
an actuator mechanism to move the streamlined valve member towards and away from the inlet air flow passage to vary the flow area of the air flow passage in the valve chamber;
an electronic controller;
an accelerator pedal position sensor associated with an accelerator pedal of the motor vehicle to provide a driver torque demand input to the electronic controller; and
an electronically controllable actuator forming part of the actuator mechanism of the throttle valve assembly operably connected to the electronic controller.

2. The system as claimed in claim 1, wherein the valve chamber and the streamlined valve member are both circular in transverse cross-section and the air flow passage is an annular air flow passage.

3. The system as claimed in claim 2, wherein moving the streamlined valve member in the valve chamber from a wide open throttle position towards the inlet passage reduces the flow area of the air flow passage and moving the streamlined valve member in the valve chamber from a fully closed position away from the inlet passage increases the flow area of the air flow passage.

4. The system as claimed in claim 3, wherein, in the wide open throttle position, a location on the valve member where the diameter of the valve member is substantially at a maximum is aligned with a location in the valve chamber where the diameter of the valve chamber is substantially at a maximum.

5. The system as claimed in claim 3, wherein, in the fully closed throttle position, a location on the valve member where the diameter of the valve member is substantially at a maximum is aligned with a location in the valve chamber close to a position where the inlet air flow passage joins the valve chamber so that a gap is provided between the wall of the valve chamber and the streamlined valve member.

6. The system as claimed in claim 3, wherein, in the fully closed throttle position, the valve member abuts a wall of the valve chamber.

7. The system as claimed in claim 1, wherein the streamlined member has a streamlined nose portion and a tail portion that tapers to a point.

8. The system as claimed in claim 1, wherein the actuator mechanism is operable to move the streamlined valve member axially along a longitudinal axis of the throttle body.

9. The system as claimed in claim 1, wherein the actuator mechanism is an electronically controllable actuator mechanism including an electric motor drivingly connected to the streamlined valve member by a threaded shaft engaged with a threaded member attached to the streamlined valve member.

10. The system as claimed in claim 1, wherein the electronic controller is arranged to operate the electronically controllable actuator to move the valve member of the throttle valve assembly based upon the input from the accelerator pedal position sensor.

11. The system as claimed in claim 10, wherein the electronic controller is operable to use the electronically controllable actuator to move the valve member in the valve chamber of the throttle valve assembly to increase an air flow area in the throttle passage of the throttle body assembly from a current air flow area if the input from the accelerator pedal position sensor indicates a request for increased engine torque.

12. The system as claimed in claim 10, wherein the electronic controller is operable to use the electronically controllable actuator to move the valve member in the valve chamber of the throttle valve assembly to reduce an air flow area in the throttle passage of the throttle body assembly from a current air flow area if the input from the accelerator pedal position sensor indicates a request for reduced engine torque.

13. A motor vehicle having an internal combustion engine and an engine air induction control system, comprising:
an air inlet flow path to an engine, including a throttle valve assembly comprising a throttle body defining inlet and outlet air flow passages connected via a divergent-convergent valve chamber;
a divergent-convergent streamlined valve member moveably mounted in the valve chamber of the throttle body to define an adjustable flow area air flow passage through the valve chamber and an actuator mechanism to move the streamlined valve member towards and away from the inlet air flow passage to vary the flow area of the air flow passage in the valve chamber;
an electronic controller;
an accelerator pedal position sensor associated with an accelerator pedal of the motor vehicle to provide a driver torque demand input to the electronic controller; and
an electronically controllable actuator forming part of the actuator mechanism of the throttle valve assembly operably connected to the electronic controller.

14. The system as claimed in claim 1, wherein moving the streamlined valve member in the valve chamber from a wide open throttle position towards the inlet passage reduces the flow area of the air flow passage and moving the streamlined valve member in the valve chamber from a fully closed position away from the inlet passage increases the flow area of the air flow passage.

15. The system as claimed in claim 4, wherein, in the fully closed throttle position, the valve member abuts a wall of the valve chamber.

16. The system as claimed in claim 6, wherein the streamlined member has a streamlined nose portion and a tail portion that tapers to a point.

17. The system as claimed in claim 7, wherein the actuator mechanism is operable to move the streamlined valve member axially along a longitudinal axis of the throttle body.

18. The system as claimed in claim 8, wherein the actuator mechanism is an electronically controllable actuator mechanism including an electric motor drivingly connected to the streamlined valve member by a threaded shaft engaged with a threaded member attached to the streamlined valve member.

19. The system as claimed in claim 9, wherein the electronic controller is arranged to operate the electronically controllable actuator to move the valve member of the throttle valve assembly based upon the input from the accelerator pedal position sensor.
